(19) United States
(12) Patent Application Publication
(10) Pub. No.: US 2013/0335646 A1
(43) Pub. Date: Dec. 19, 2013

(54) DISPLAY PANEL OF STEREOSCOPIC IMAGE DISPLAY

(71) Applicants: Qiaosheng Liao, Shenzhen (CN); Chia-chiang Hsiao, Shenzhen (CN); Chih-Wen Chen, Shenzhen (CN)

(72) Inventors: Qiaosheng Liao, Shenzhen (CN); Chia-chiang Hsiao, Shenzhen (CN); Chih-Wen Chen, Shenzhen (CN)

(73) Assignee: SHENZHEN CHINA STAR OPTOELECTRONICS TECHNOLOGY CO. LTD., Shenzhen (CN)

(21) Appl. No.: 13/574,527

(22) PCT Filed: Jun. 21, 2012
(86) PCT No.: PCT/CN12/77288

§ 371 Date: Jul. 20, 2012

(30) Foreign Application Priority Data
Jun. 19, 2012 (CN) 201210203096.2

(51) Int. Cl. G02F 1/13

(52) U.S. Cl. CPC G02F 1/1313
USPC 349/15

(57) ABSTRACT

The present invention provides a display panel of a stereoscopic image display. The display panel comprises a plurality of pixel areas. The red, green, and blue sub pixels of one pixel area are arranged in series along a vertical direction. In every pixel area, the blue sub pixel is located at a central position while the red and the green sub pixels are located at upper and lower positions. This arrangement can further reduce the viewing angle of the display panel of the stereoscopic image display, improve the ability to keep the displayed content safe, and prevent information from leaked out.

### BACKGROUND OF THE INVENTION

1. Field of the Invention

The present invention relates to a stereoscopic image display technology, and more particularly, to a display panel of a stereoscopic image display.

2. Description of Prior Art

As liquid crystal displays grow vigorously, stereoscopic image displays or 3D displays which can show stereoscopic images or three-dimensional images have been marketed. The 3D displays can show distance relationship of respective parts of an object and that is consistent with human visual perception. Hence, the 3D displays may well become a development trend of next-generation displays.

FIG. 1 is a schematic diagram illustrating how a conventional stereoscopic display works. The conventional stereoscopic display adopts a pattern retarder technique. A user wearing a pair of polarized light eyeglasses can see three-dimensional images displayed by the aforesaid stereoscopic display. As shown in FIG. 1, the display has a linear polarization filter 12 disposed at one side of a thin-film transistor array substrate (not shown) and a 1/4λ pattern retarder plate 14 disposed at one side of a color filter substrate (not shown). Light rays emitted from a backlight module (not shown) of the display will be polarized and become linearly polarized light after passing the linear polarization filter 12. The angle between a transmission axis of the linear polarization filter 12 and a horizontal direction H is 90°. Hence, only the light rays polarized in a vertical direction can pass the linear polarization filter 12. It may be said that light rays that already pass the linear polarization filter 12 are vertically polarized light rays. In addition, the 1/4λ pattern retarder plate 14 has two types of transmission axes. One is 45° with respect to the horizontal direction. The other is 135° with respect to the horizontal direction. These transmission axes are arranged alternatively along the vertical direction, as shown in FIG. 1. Accordingly, the vertically polarized light rays from the linear polarization filter 12 become left-handed circularly polarized light and right-handed circularly polarized light after passing the 1/4λ pattern retarder plate 14.

The pair of the polarized light eyeglasses 16 that is arranged with the stereoscopic display consists of λ/4 wave plates 161, 162 and vertical polarizers 163, 164. The λ/4 wave plates 161, 162 can be respectively attached to the vertical polarizers 163, 164 to construct the polarized light eyeglasses 16. The λ/4 wave plates 161 corresponding to a left eyeglass for a left eye may have a 45° transmission axis. The λ/4 wave plates 162 corresponding to a right eyeglass for a right eye may have a 135° transmission axis. The vertical polarizers 163, 164 have transmission axes that are perpendicular to the horizontal direction H. Accordingly, the left-handed circularly polarized light from the 1/4λ pattern retarder plate 14 can pass the right eyeglass and then go into the right eye of a viewer. The left-handed circularly polarized light will be blocked or absorbed by the left eyeglass and thus will not go into the left eye of the viewer. The right-handed circularly polarized light from the 1/4λ pattern retarder plate 14 can pass the left eyeglass and then go into the left eye of the viewer. The right-handed circularly polarized light will be blocked or absorbed by the right eyeglass and thus will not go into the right eye of the viewer.

Consequently, the viewer's left eye may only receive the images provided for the left eye and the viewer's right eye may only receive the images provided for the right eye through the polarized light eyeglasses 16 as long as image pixels of the right-eye images and the left-eye images are arranged respectively corresponding to the transmission axes 45°, 135° of the 1/4λ pattern retarder plate 14 appropriately such that the right-eye images may correspond to the left-handed circularly polarized light and the left-eye images may correspond to the right-handed circularly polarized light, and vice versa, after emitted from the 1/4λ pattern retarder plate 14. In such a manner, the viewer can sense a three-dimensional image while the left eye receives the left-eye images and the right eyes receives the right-eye images.

FIG. 2 is a schematic diagram showing a conventional pixel arrangement for a display panel. FIG. 3 is a schematic diagram showing another conventional pixel arrangement for a display panel. The display panel comprises a plurality of pixel areas. Each pixel area at least comprises a red sub pixel (R), a green sub pixel (G), and a blue sub pixel (B). As shown in FIG. 2 and FIG. 3, the sub pixels 17 on the display panel are defined by areas formed by interlacing scan lines 11 with data lines 13. Each sub pixel 17 has a transistor 15 disposed therein for controlling data signals to be written in. For the display panel shown in FIG. 2, the RGB sub pixels of one pixel area are arranged in series along a horizontal direction. For the display panel shown in FIG. 3, the RGB sub pixels of one pixel area are arranged in series along a vertical direction. The pixel structure of FIG. 3 is a so-called tri-grate type. The feature of the tri-gate pixel structure is that the RGB sub pixels share the same data signal. Hence, the number of the data lines as a whole can be reduced. The number of source driving ICs is reduced, accordingly. The pixel structure of FIG. 3 will make the number of the scan lines and the number of gate driving ICs increased. However, the source driving IC is much expensive and its cost is relatively high. Therefore, adopting the tri-gate pixel structure can reduce the number of the source driving ICs and reduce the cost as well.

FIG. 4 is a schematic diagram showing a conventional stereoscopic image display combing a tri-gate pixel structure and a film-type pattern retarder (FPR). As shown in FIG. 4, the film-type pattern retarder 19 is formed by a 1/4λ and −1/4λ composite retarder film, e.g., one row for the 1/4λ retarder, next row for the −1/4λ retarder, and 1/4λ retarder again for the next, and so on. The function of the film-type pattern retarder 19 of FIG. 4 is similar to the 1/4λ pattern retarder plate 14 shown in FIG. 1, which can transform the linear polarized light into the left-handed circularly polarized light and the right-handed circularly polarized light. That is to say, after passing the 1/4λ and −1/4λ composite retarder film, the linear polarized light will become the left-handed circularly polarized light and the right-handed circularly polarized light. After the left-handed and the right-handed circularly polarized light further passes the λ/4 wave plates and the vertical polarizer of the polarized light eyeglasses, they will go to the viewer's left eye and right eye, respectively. The viewer's left eye and right eye respectively receive two images that are slightly different and these two images are combined in the brain to get a 3D image perception.

Moreover, when a user uses a display device, the user may dislike a situation that the displayed content (e.g., all kinds of documents) is seen by any other person. Therefore, developing a technology for keeping information secure and preventing the information from being leaked out is also an important issue for the 3D displays.

The 3D displays inherently have a problem with image crosstalk and originally have small viewing angles. Hence, the 3D displays have a certain ability to prevent the information from being leaked out but there is still much room to improve it. The so-called image crosstalk is that one eye sees the signals that ought to be provided to another eye. For example, the viewer's right eye receives the images that are predetermined to be provided for the left eye and the viewer's left eye receives the images that are predetermined to be provided for the right eye. The interference signals are overlapped with original data signals and hence this causes a ghost image. The more serious the image crosstalk is, the smaller the viewing angle will be.

FIG. 5 is a schematic diagram showing a conventional 3D display system adopting a 1/4λ pattern retarder film. As shown in FIG. 5, the display panel is divided into left pixel areas 181 provided for displaying left-eye images and right pixel areas 182 provided for displaying right-eye images in order to show three-dimensional images. Black matrixes (BM) 183 are disposed between the respective sub pixels for avoiding light leakage. When light rays emitted from the left pixel area 181 near a position of a border of the black matrix are propagated with an angle greater than θ, the light rays may enter the pattern retarder film corresponding to the right eye until being received by the viewer's right eye via the right eyeglass. This causes image crosstalk.

In another aspect, FIG. 6 is a schematic diagram illustrating a conventional approach to reduce a viewing angle by decreasing the width of a black matrix. The black matrixes of FIG. 6 are wider than the black matrixes shown in FIG. 5. Increasing the width of black matrix may greatly reduce the amount of light rays emitted in a large angle. Accordingly, the viewer may not clearly see the displayed image when viewing from the side. This may be helpful in keeping the displayed content secure for a certain degree. However, this approach may make the brightness of entire display panel reduced and this is not good for image contrast and image quality.

Above all, how to improve information security for the 3D displays is an important issue in this industry.

### SUMMARY OF THE INVENTION

An objective of the present invention is to provide a display panel of a stereoscopic image display for reducing a viewing angle for the display panel, improving the ability to keep the displayed content safe, and preventing information from leaked out.

To solve the above problem, the present invention provides a display panel of a stereoscopic image display, comprising: a backlight plate for providing backlight; a thin-film transistor array substrate comprising a plurality of pixel areas, each pixel area at least comprises a red sub pixel, a green sub pixel, and a blue sub pixel, the thin-film transistor array substrate has a plurality of scan lines and data lines disposed thereon, each sub pixel is defined by areas formed by interlacing the scan lines with the data lines; a color filter substrate having red, green, and blue filters disposed respectively corresponding to the red, green, and blue sub pixels on the thin-film transistor array substrate; and a first polarizer and a second polarizer disposed respectively at a rear side and a front side of the display panel, light rays emitted from the backlight plate become polarized light rays having two different polarization directions after passing the first polarizer and then the second polarizer; wherein the red, green, and blue sub pixels of one pixel area are arranged in series along a vertical direction, and in every pixel area, the blue sub pixel is located at a central position while the red and the green sub pixels are located at upper and lower positions.

In one embodiment of the present invention, in every pixel area of the thin-film transistor array substrate, the red sub pixel is located at the upper position, the blue sub pixel is located at the central position, and the green sub pixel is located at the lower position.

In one embodiment of the present invention, in every pixel area of the thin-film transistor array substrate, the green sub pixel is located at the upper position, the blue sub pixel is located at the central position, and the red sub pixel is located at the lower position.

In one embodiment of the present invention, the first polarizer is a polarization filter, of which a transmission axis is perpendicular to a horizontal direction; and the second polarizer is a pattern retarder film, which consists of a plurality of 1/4λ retarder blocks and −1/4λ retarder blocks, light rays emitted from the backlight plate become left-handed circularly polarized light and right-handed circularly polarized light after passing the polarization filter and then the pattern retarder film.

In another aspect, the present invention provides a display panel of a stereoscopic image display, comprising: a backlight plate for providing backlight; a thin-film transistor array substrate comprising a plurality of pixel areas, each pixel area at least comprises a red sub pixel, a green sub pixel, and a blue sub pixel, the thin-film transistor array substrate has a plurality of scan lines and data lines disposed thereon, each sub pixel is defined by areas formed by interlacing the scan lines with the data lines; a color filter substrate having red, green, and blue filters disposed respectively corresponding to the red, green, and blue sub pixels on the thin-film transistor array substrate; a polarization filter disposed at a side of the thin-film transistor array substrate, a transmission axis of the polarization filter is perpendicular to a horizontal direction; and a pattern retarder film disposed at a side of the color filter substrate, the pattern retarder film consists of a plurality of 1/4λ retarder blocks and −1/4λ retarder blocks, light rays emitted from the backlight plate become left-handed circularly polarized light and right-handed circularly polarized light after passing the polarization filter and then the pattern retarder film; wherein the red, green, and blue sub pixels of one pixel area are arranged in series along a vertical direction, and in every pixel area, the blue sub pixel is located at a central position while the red and the green sub pixels are located at upper and lower positions.

In one embodiment of the present invention, in every pixel area of the thin-film transistor array substrate, the red sub pixel is located at the upper position, the blue sub pixel is located at the central position, and the green sub pixel is located at the lower position.

In one embodiment of the present invention, in every pixel area of the thin-film transistor array substrate, the green sub pixel is located at the upper position, the blue sub pixel is located at the central position, and the red sub pixel is located at the lower position.

In yet another aspect, the present invention provides a display panel of a stereoscopic image display, in which the display panel has a first polarizer and a second polarizer respectively disposed at a rear side and a front side thereof, backlight of the display panel becomes polarized light having two different polarization directions after passing the first polarizer and then the second polarizer, said display panel comprising: a plurality of scan lines and a plurality of data lines; and a plurality of pixel area, each pixel area at least comprises a red sub pixel, a green sub pixel, and a blue sub pixel, each sub pixel is defined by areas formed by interlacing the scan lines with the data lines, each pixel area corresponds at least three scan lines and one data line, said three scan lines provide scan signals respectively to the red, green, and blue sub pixels, the red, green, and blue sub pixels receive data signals through the same data line; wherein the red, green, and blue sub pixels of one pixel area are arranged in series along a vertical direction, and in every pixel area, the blue sub pixel is located at a central position while the red and the green sub pixels are located at upper and lower positions.

In one embodiment of the present invention, in every pixel area, the red sub pixel is located at the upper position, the blue sub pixel is located at the central position, and the green sub pixel is located at the lower position.

In one embodiment of the present invention, in every pixel area, the green sub pixel is located at the upper position, the blue sub pixel is located at the central position, and the red sub pixel is located at the lower position.

In the present invention, the red, green, and blue sub pixels of one pixel area are arranged in series along a vertical direction, and in every pixel area, the blue sub pixel is located at a central position while the red and the green sub pixels are located at upper and lower positions. This arrangement can further reduce the viewing angle of the display panel of the stereoscopic image display, improve the ability to keep the displayed content safe, and prevent information from leaked out.

To make above content of the present invention more easily understood, it will be described in details by using preferred embodiments in conjunction with the appending drawings.

### BRIEF DESCRIPTION OF THE DRAWINGS

FIG. 1 is a schematic diagram illustrating how a conventional stereoscopic display works.

FIG. 2 is a schematic diagram showing a conventional pixel arrangement for a display panel.

FIG. 3 is a schematic diagram showing another conventional pixel arrangement for a display panel.

FIG. 4 is a schematic diagram showing a conventional stereoscopic image display combing a tri-gate pixel structure and a film-type pattern retarder (FPR).

FIG. 5 is a schematic diagram showing a conventional 3D display system adopting a 1/4λ pattern retarder film.

FIG. 6 is a schematic diagram illustrating a conventional approach to reduce a viewing angle by decreasing the width of a black matrix.

FIG. 7 is a schematic diagram showing a display panel of a stereoscopic image display according to the present invention.

FIG. 8 is a schematic diagram showing a pair of polarized light eyeglasses that matches the display panel of the stereoscopic image display of the present invention.

FIG. 9 is a schematic diagram showing an example of a pattern retarder film and a pixel structure arranged on a thin-film transistor array substrate and a color filter substrate shown in FIG. 7.

FIG. 10 is a schematic diagram showing another example of a pattern retarder film and a pixel structure arranged on a thin-film transistor array substrate and a color filter substrate shown in FIG. 7.

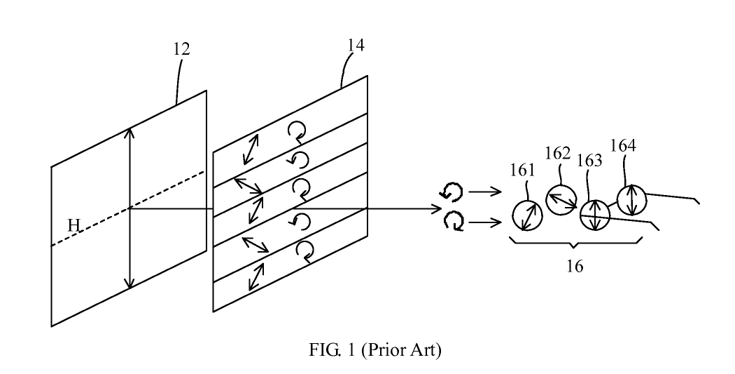

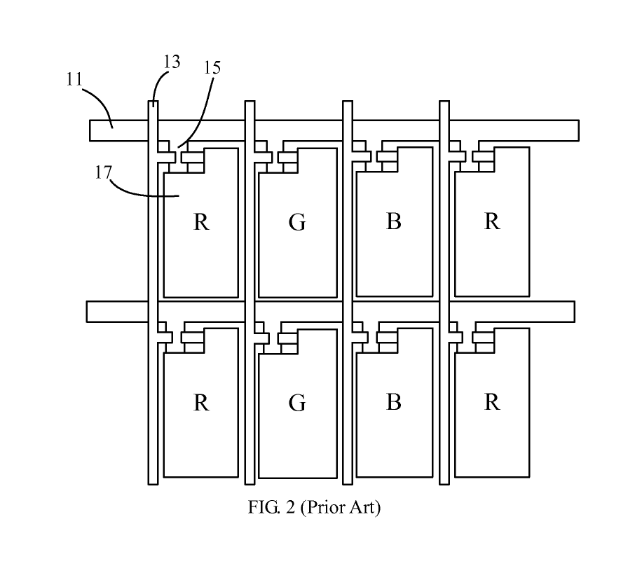

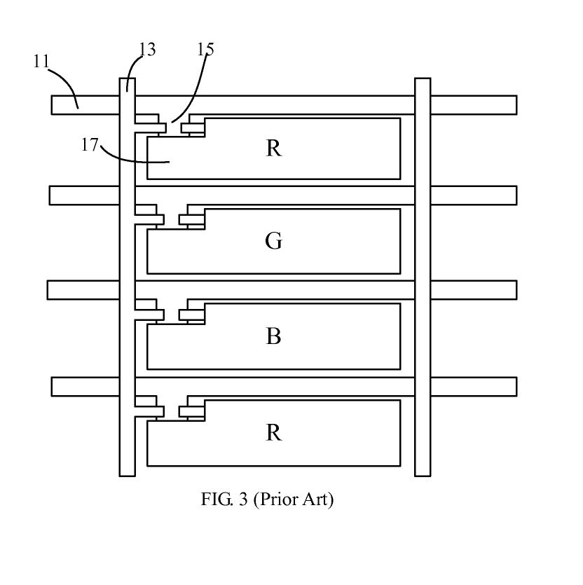

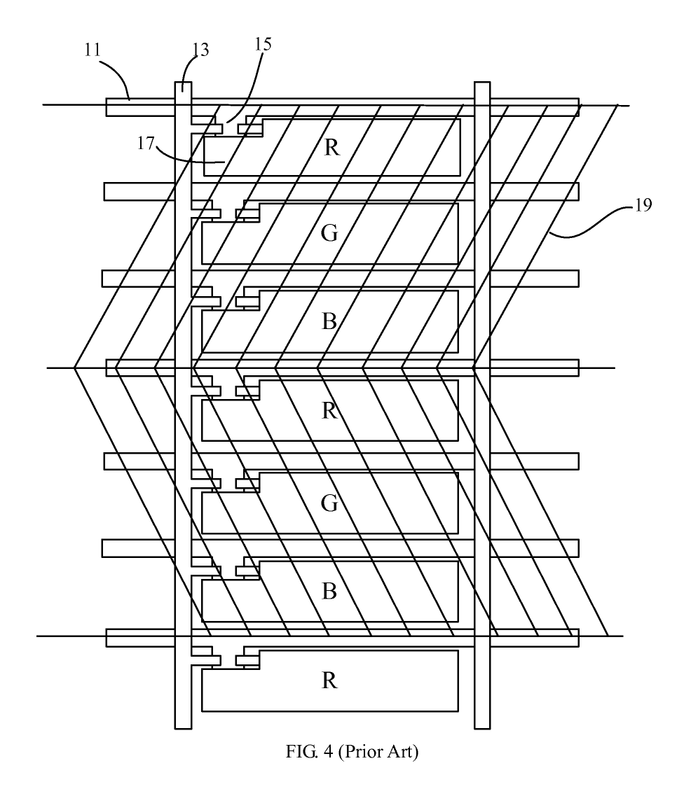

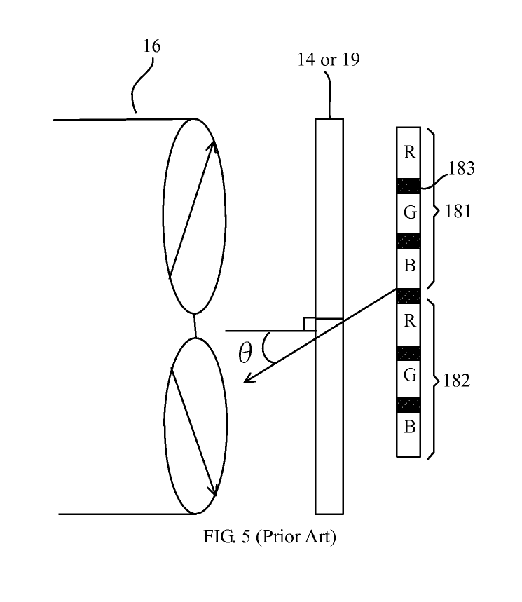

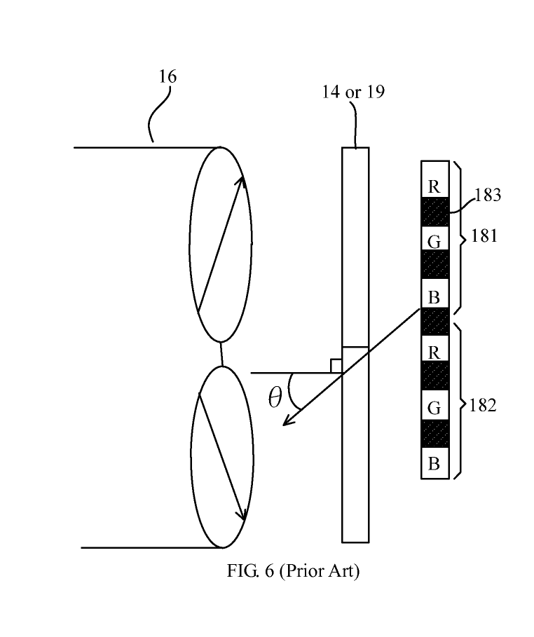

### DETAILED DESCRIPTION OF THE PREFERRED EMBODIMENTS

The following descriptions for the respective embodiments are specific embodiments capable of being implemented for illustrations of the present invention with referring to appended figures. In the descriptions of the present invention, spatially relative terms, such as “upper”, “lower”, “front”, “back”, “left”, “right”, “top”, “bottom”, “horizontal”, “vertical”, and the like, may be used herein for ease of description as illustrated in the figures. Therefore, it will be understood that the spatially relative terms are intended to illustrate for understanding the present invention, but not to limit the present invention.

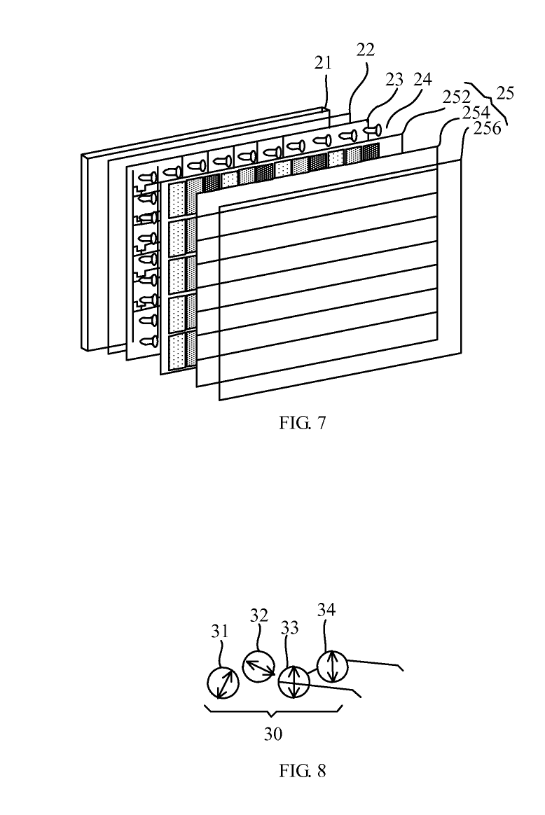

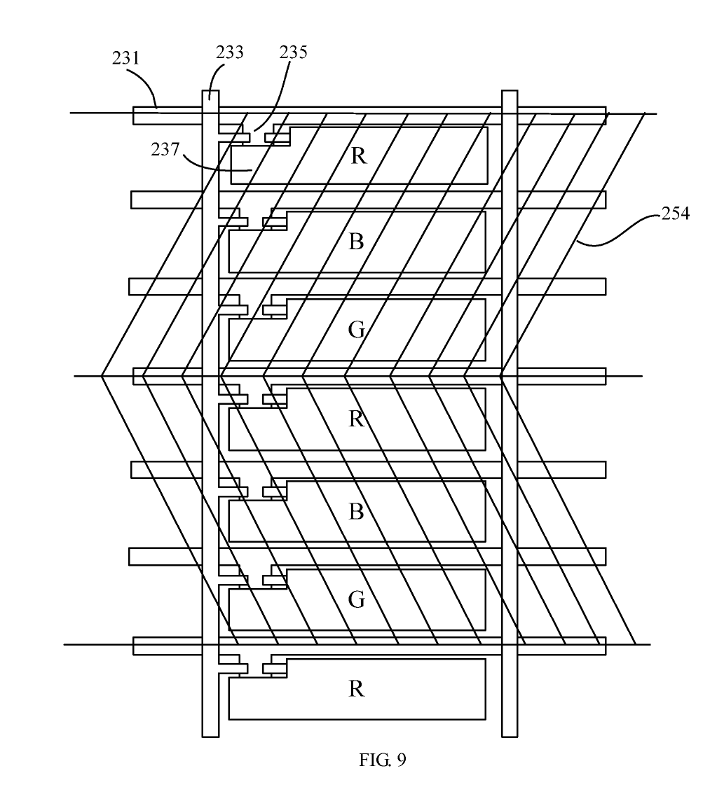

FIG. 7 is a schematic diagram showing a display panel of a stereoscopic image display according to the present invention. FIG. 8 is a schematic diagram showing a pair of polarized light eyeglasses that matches the display panel of the stereoscopic image display of the present invention. As shown in FIG. 7, the display panel of the stereoscopic image display of the present invention comprises a backlight plate 21, a polarization filter 22, a thin-film transistor array substrate 23, a liquid crystal layer 24, and a color filter substrate 25. The liquid crystal layer 24 is disposed between the thin-film transistor array substrate 23 and the color filter substrate 25. The color filter substrate 25 may comprise a filter array 252 constructed by red (R), green (G), and blue (B) filters, a polarization filter 254, and a glass carrier 256. As shown in FIG. 8, the pair of polarized light eyeglasses 30 may consist of left and right polarization eyepieces 33, 34, and polarization films 31, 32 correspondingly attached thereto.

The backlight plate 21 is used for providing backlight, for example, cold-cathode tubes and light emitting diodes (LEDs). The polarization filter 22 is disposed at a rear side of the display panel while the polarization filter 254 is disposed at a front side of the display panel. The polarization filters 22, 254 are used to polarize light rays. The light rays provided by the backlight plate 21 will be polarized after passing the polarization filter 22. Thin-film transistors disposed on the thin-film transistor array substrate 52 can control twisting angles of liquid crystal molecules of the liquid crystal layer 54 so as to alter polarization of the light rays. The light rays having different polarization enter the polarization filter 254 after passing the red, green, and blue filter array 252 of the color filer substrate 56. The light rays from the polarization filter 254 have two different polarization directions. This can be designed appropriately such that the images provided for a viewer's left eye correspond to a first polarization direction and the images provided for the viewer's right eye correspond to a second polarization direction. The polarized light eyeglasses 30 are well designed such that the left eyepiece only allows the left-eye images corresponding to the first polarization direction to pass through and the right eyepiece only allows the right-eye images corresponding to the second polarization direction to pass through. In such a manner, when the viewer wears the polarized light eyeglasses 30, the viewer's left eye only sees the left-eye images provided by the display and the viewer's right eye only sees the right-eye images provided by the display. Hence, the viewer can get a three-dimensional image perception under a parallax principle.

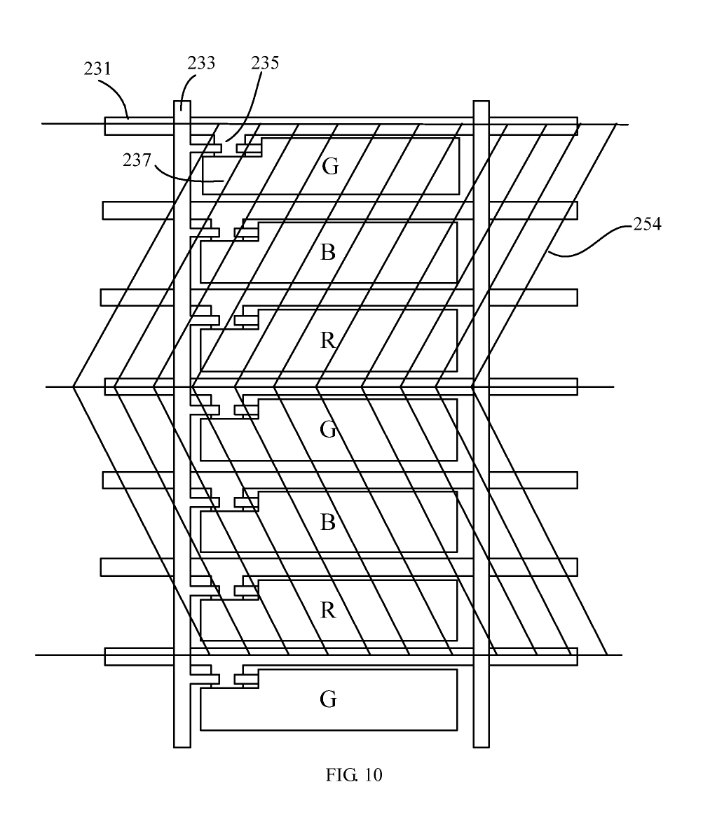

For example, the polarization filter 22 is a linear polarization filter. The angle between a transmission axis of the linear polarization filter 22 and a horizontal direction is 90°. Hence, only the light rays polarized in a vertical direction can pass the linear polarization filter 22. The light rays able to pass the linear polarization filter 22 are vertically polarized light rays. The polarization filter 254 is a film-type patterned retarder (FPR), which is formed by a 1/4λ and −1/4λ composite retarder film. The 1/4λ retarder and the −1/4λ retarder are arranged alternatively along the vertical direction, e.g., one row for the 1/4λ retarder, next row for the −1/4λ retarder, and 1/4λ retarder again for the next, and so on (see FIG. 9). As a result, the polarized light from the linear polarization filter 22 will become left-handed circularly polarized light and right-handed circularly polarized light after passing the pattern retarder film 254. In another aspect, in the polarized light eyeglasses 30 arranged with the display panel of the stereoscopic image display, the 1/4λ film 31 corresponding to the left eyepiece has a 45° transmission axis and the 1/4λ film 32 corresponding to the right eyepiece has a 135° transmission axis. The transmission axes of the left and the right polarization eyepieces 33, 34 are perpendicular to the horizontal direction. Accordingly, the left-handed circularly polarized light from the pattern retarder film 254 can pass the right eyepiece and then go into the right eye of a viewer. The left-handed circularly polarized light will be blocked or absorbed by the left eyepiece and thus will not go into the left eye of the viewer. The right-handed circularly polarized light from the pattern retarder film 254 can pass the left eyepiece and then go into the left eye of the viewer. The right-handed circularly polarized light will be blocked or absorbed by the right eyepiece and thus will not go into the right eye of the viewer.

In one embodiment, the pattern retarder film 254 can be attached to the glass carrier 256 of the color filter substrate 25 and then the filter array 252 is formed thereon, as shown in FIG. 7. In another embodiment, it also can form the filter array 252 on the glass carrier 252 and then form the pattern retarder film 254 thereon.

FIG. 9 is a schematic diagram showing an example of a pattern retarder film and a pixel structure arranged on a thin-film transistor array substrate and a color filter substrate shown in FIG. 7. As shown in FIG. 9, the thin-film transistor array substrate 23 has a plurality of scan lines 231 and a plurality of data lines 233 disposed thereon. The scan lines 231 are used to provide scan signals. The data lines 233 are used to provide pixel data. Transistors 235 are disposed at the intersection of the scan lines 231 and the data lines 233. The transistors 235 are used to control the pixel data to be written in. The thin-film transistor array substrate 23 comprises a plurality of pixel areas 237. Each pixel area 237 at least comprises a red sub pixel, a green sub pixel, and a blue sub pixel. Each sub pixel is defined by areas formed by interlacing the scan lines 231 with the data lines 233. In another aspect, the color filter substrate 25 has red, green, and blue filters (e.g., the red, green, and blue color blocks of the filter array 252 as shown in FIG. 7) disposed respectively corresponding to the red, green, and blue sub pixels on the thin-film transistor array substrate 23.

The pixel structure shown in FIG. 9 is a tri-gate pixel structure. In such a structure, the red, green, and blue sub pixels of one pixel area are arranged in series along a vertical direction. Each pixel area corresponds to at least three scan lines 231 and one data line 233. The three scan lines 231 provide scan signals to the red, green, and blue sub pixels, respectively. The red, green, and blue sub pixels receive the pixel data via the same data line 233. The advantages of this pixel structure are that the number of the data lines as a whole can be reduced, the number of source driving ICs is decreased accordingly, and the cost is reduced as well. The pixel structure of FIG. 9 will make the number of the scan lines and the number of gate driving ICs increased. However, the source driving IC is much expensive and its cost is relatively high. Therefore, adopting the tri-gate pixel structure can decrease the number of the source driving ICs and reduce the cost as well.

In the present invention, the red, green, and blue sub pixels of one pixel area are arranged in series along a vertical direction (i.e., the tri-gate type). In every pixel area, the blue sub pixel is located at a central position while the red and the green sub pixels are located at upper and lower positions. In one embodiment, in every pixel area, the red sub pixel is located at the upper position, the blue sub pixel is located at the central position, and the green sub pixel is located at the lower position, as shown in FIG. 9. In another embodiment, in every pixel area, the green sub pixel is located at the upper position, the blue sub pixel is located at the central position, and the red sub pixel is located at the lower position, as shown in FIG. 10. This arrangement can further reduce the viewing angle of the display panel of the stereoscopic image display, improve the ability to keep the displayed content safe, and prevent information from leaked out. This is because the green color has the most stimulation effect to human eyes, i.e., human eyes are most sensitive to the green color, next is the red color, and lest is the blue color. In the present invention, the red sub pixel and the green sub pixel in each pixel area are located at upper and lower positions. This can make image crosstalk more intensive when presenting three-dimensional images. Accordingly, the viewing angle is reduced, and thereby keeping the displayed content safe.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. A display panel of a stereoscopic image display, comprising:
a backlight plate for providing backlight;
a thin-film transistor array substrate comprising a plurality of pixel areas, each pixel area at least comprises a red sub pixel, a green sub pixel, and a blue sub pixel, the thin-film transistor array substrate has a plurality of scan lines and data lines disposed thereon, each sub pixel is defined by areas formed by interlacing the scan lines with the data lines;
a color filter substrate having red, green, and blue filters disposed respectively corresponding to the red, green, and blue sub pixels on the thin-film transistor array substrate;
a polarization filter disposed at a side of the thin-film transistor array substrate, a transmission axis of the polarization filter is perpendicular to a horizontal direction; and
a pattern retarder film disposed at a side of the color filter substrate, the pattern retarder film consists of a plurality of 1/4λ retarder blocks and −1/4λ retarder blocks, light rays emitted from the backlight plate become left-handed circularly polarized light and right-handed circularly polarized light after passing the polarization filter and then the pattern retarder film;
wherein the red, green, and blue sub pixels of one pixel area are arranged in series along a vertical direction, and in every pixel area, the blue sub pixel is located at a central position while the red and the green sub pixels are located at upper and lower positions.

2. The display panel of the stereoscopic image display according to claim 1, wherein in every pixel area of the thin-film transistor array substrate, the red sub pixel is located at the upper position, the blue sub pixel is located at the central position, and the green sub pixel is located at the lower position.

3. The display panel of the stereoscopic image display according to claim 1, wherein in every pixel area of the thin-film transistor array substrate, the green sub pixel is located at the upper position, the blue sub pixel is located at the central position, and the red sub pixel is located at the lower position.

4. A display panel of a stereoscopic image display, comprising:
a backlight plate for providing backlight;
a thin-film transistor array substrate comprising a plurality of pixel areas, each pixel area at least comprises a red sub pixel, a green sub pixel, and a blue sub pixel, the thin-film transistor array substrate has a plurality of scan lines and data lines disposed thereon, each sub pixel is defined by areas formed by interlacing the scan lines with the data lines;
a color filter substrate having red, green, and blue filters disposed respectively corresponding to the red, green, and blue sub pixels on the thin-film transistor array substrate; and
a first polarizer and a second polarizer disposed respectively at a rear side and a front side of the display panel, light rays emitted from the backlight plate become polarized light rays having two different polarization directions after passing the first polarizer and then the second polarizer;
wherein the red, green, and blue sub pixels of one pixel area are arranged in series along a vertical direction, and in every pixel area, the blue sub pixel is located at a central position while the red and the green sub pixels are located at upper and lower positions.

5. The display panel of the stereoscopic image display according to claim 4, wherein in every pixel area of the thin-film transistor array substrate, the red sub pixel is located at the upper position, the blue sub pixel is located at the central position, and the green sub pixel is located at the lower position.

6. The display panel of the stereoscopic image display according to claim 4, wherein in every pixel area of the thin-film transistor array substrate, the green sub pixel is located at the upper position, the blue sub pixel is located at the central position, and the red sub pixel is located at the lower position.

7. The display panel of the stereoscopic image display according to claim 4, wherein
the first polarizer is a polarization filter, of which a transmission axis is perpendicular to a horizontal direction; and
the second polarizer is a pattern retarder film, which consists of a plurality of 1/4λ retarder blocks and −1/4λ retarder blocks, light rays emitted from the backlight plate become left-handed circularly polarized light and right-handed circularly polarized light after passing the polarization filter and then the pattern retarder film.

8. A display panel of a stereoscopic image display, in which the display panel has a first polarizer and a second polarizer respectively disposed at a rear side and a front side thereof, backlight of the display panel becomes polarized light having two different polarization directions after passing the first polarizer and then the second polarizer, said display panel comprising:
a plurality of scan lines and a plurality of data lines; and
a plurality of pixel area, each pixel area at least comprises a red sub pixel, a green sub pixel, and a blue sub pixel, each sub pixel is defined by areas formed by interlacing the scan lines with the data lines, each pixel area corresponds at least three scan lines and one data line, said three scan lines provide scan signals respectively to the red, green, and blue sub pixels, the red, green, and blue sub pixels receive data signals through the same data line;
wherein the red, green, and blue sub pixels of one pixel area are arranged in series along a vertical direction, and in every pixel area, the blue sub pixel is located at a central position while the red and the green sub pixels are located at upper and lower positions.

9. The display panel of the stereoscopic image display according to claim 8, wherein in every pixel area, the red sub pixel is located at the upper position, the blue sub pixel is located at the central position, and the green sub pixel is located at the lower position.

10. The display panel of the stereoscopic image display according to claim 8, wherein in every pixel area, the green sub pixel is located at the upper position, the blue sub pixel is located at the central position, and the red sub pixel is located at the lower position.
